(19) United States
(12) Patent Application Publication
(10) Pub. No.: US 2022/0292661 A1
(43) Pub. Date: Sep. 15, 2022

(54) AUTOMATED INSPECTION SYSTEM AND OPERATING METHOD THEREOF

(71) Applicant: ADLINK TECHNOLOGY INC., New Taipei (TW)

(72) Inventors: Chua-Hong NG, New Taipei (TW); Ming-Che CHENG, New Taipei (TW)

(21) Appl. No.: 17/197,739

(22) Filed: Mar. 10, 2021

(51) Int. Cl. G06T 7/00; G06T 7/10; G06K 9/00; G06K 9/62; G06N 3/08

(52) U.S. Cl. CPC G06T 7/0002; G06T 7/10; G06K 9/00671; G06K 9/6263; G06N 3/08; G06T 2207/20132; G06K 2209/01

(57) ABSTRACT

An automated inspection system includes a machine-vision inspection device, a repair station and an artificial intelligence module connected to the machine-vision inspection device, and a processing platform connected to the repair station and the artificial intelligence module. The machine-vision inspection device obtains an image of a to-be-inspected object and displays the image on an operation screen of the repair station, the artificial intelligence module retrieves the image of the to-be-inspected object to perform inference for classification, the processing platform automatically overlaps result data of classification inference for the image of the to-be-inspected object on the operation screen of the repair station, and intercepts and transmits result data of manual review, which is inputted by an operator through a user interface, to the repair station. The processing platform then transmits the result data of manual review to the artificial intelligence module as the data for automatically re-training a classification model.

### BACKGROUND OF THE INVENTION

1. Field of the Invention

The present invention provides a system and a method, and more particularly to an automated inspection system and an operating method thereof

2. Description of the Related Art

With the advancement of science and technology, the sizes of electronic components are reduced while the precision requirements are increasing. Therefore, in order to ensure the improvement of product yield, it is necessary to conduct inspections at various important stations in the modem manufacturing process to facilitate detecting products with defects as early as possible, so as to reduce waste in manufacturing process and increase output and yield of production line. However, more inspection operations also make more time consumed by the process. In order to speed up the inspection time, the automatic inspection technology such as automatic visual inspection and automatic optical inspection becomes an indispensable role in the manufacturing process.

The general automatic inspection apparatus is commonly used in appearance inspection in a circuit board assembly production line to replace the manual visual inspection operation. For example, the automatic inspection apparatus can be used to inspect quality condition of the soldering for metal parts on the circuit hoard and assembled circuit hoard. The basic principle of the automatic inspection apparatus is to use digital image processing technology to compare whether there are too many different parts between the inspected object and the standard image, to determine whether the inspected object meets the standard. However, conventional automated inspection apparatus may have a high false positive rate because of color difference and height difference, and waste more manpower to review and handle the abnormal inspection result.

With the rise of modem Industry 4.0 and smart manufacturing, quality inspection is one of the most important procedures to ensure production line yield and product quality in smart factories requiring high production efficiency and quality. In conventional manner, the automated inspection apparatus was often used to assist on-site production line personnel to improve accuracy rate of inspection. As the application of artificial intelligence technology becomes the mainstream and gradually mature, some companies start to integrate the artificial intelligence technology with the automated inspection apparatus to make the defect detection of automated inspection apparatus more accurate by using the machine learning or the deep learning algorithm, so as to decrease the false positive rate of automated inspection apparatus and reduce labor costs. However, the machine learning or deep learning technology used by the manufacturer must perform a trained model first, and then the results of trained model are downloaded to the on-site automated inspection apparatus or the terminal apparatus to perform an inference. The biggest problem in the creation of the trained model is that the ratio of defective samples to good samples is very low, and the lack of defective samples causes difficulty in effectively training the model capable of identifying the defects.

Therefore, in the era of automated production in smart factories, as the application of artificial intelligence technology has become the mainstream, what is needed is to develop a system which can introduce the artificial intelligence technology into the automated inspection apparatus to further decrease the missed detection rate or false positive rate, so as to shorten the overall inspection process, reduce labor costs, improve the output and yield rate of the production line, and the system also can collect the on-site manual review results as data for subsequent model training to improve the accuracy of classification or identification of the object to be inspected, to make the inspection quality better.

### SUMMARY OF THE INVENTION

In order to solve the above-mentioned problems, the inventors develop an automated inspection system which collects manual review results in site as the data for re-training a classification model, and also develop an operating method of the automated inspection system, according to collected data, multiple tests and modifications, and years of experience in the industry.

An objective of the present invention is that an automated inspection system of the present invention is in a non-invasive design and can be installed in a product line without stopping the production line, and can also be applied to a machine-vision inspection device already used in the production line; when the machine-vision inspection device inspects the image of the to-be-inspected object having defect, the artificial intelligence module can automatically perform inference for defect classification by deep learning algorithm, the processing platform can overlap and display the inference result for classification of the image of the to-be-inspected object on the operation screen of the repair station by an automatic insertion or filling manner, so that manual inspection items can be decreased to make the operator focus on review to improve the operation quality. When the operator performs the review, the processing platform can intercept the result data of manual review inputted by the operator through the input unit, and then transmit the result data of manual review to the artificial intelligence module as the data for automatically re-training the classification model, so as to further decrease the false positive rate of the automated inspection system and improve the quality of inspection.

Another objective of the present invention is that when the operator determines the defect labelled by AI on the image is different from the defect labelled by the operator, it indicates that the AI inference result for classification is different from the practical result labelled in the manual review, the processing platform can collect the manual review results as the data for re-training the artificial intelligence module, to achieve the effect of preventing the same or similar misjudged samples from being misjudged again in further inspection process, thereby improving the accuracy in classification determination or recognition. Furthermore, all of the operator's past operating behaviors are stored to make the operator familiar with the new function added in the existing system, to shorten the learning curve of the operator with the interactive operation screen, so that the inspection process can be shortened, the production capacity can be improved. Furthermore, the software and hardware of the automated inspection system of the present invention can be plugged in the original automated optical inspection apparatus system to effectively and easily upgrade the original system and apparatus, and reduce the complicated manual review inspection items, effectively reduce labor costs, and improve production and yield rate of the production line.

### BRIEF DESCRIPTION OF THE DRAWINGS

The structure, operating principle and effects of the present invention will be described in detail by way of various embodiments which are illustrated in the accompanying drawings.

FIG. 1 is a schematic architecture view of an automated inspection system of the present invention.

FIG. 2 is a flowchart of an operating method of the present invention.

FIG. 3 is a schematic view showing an operation of intercepting a review result, inputted by the operator, and training artificial intelligence according to the review result and transmitting the same review result to a repair station.

FIG. 4 is a schematic view showing an operation of overlapping an AI inference result for classification on an operation screen, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

it will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

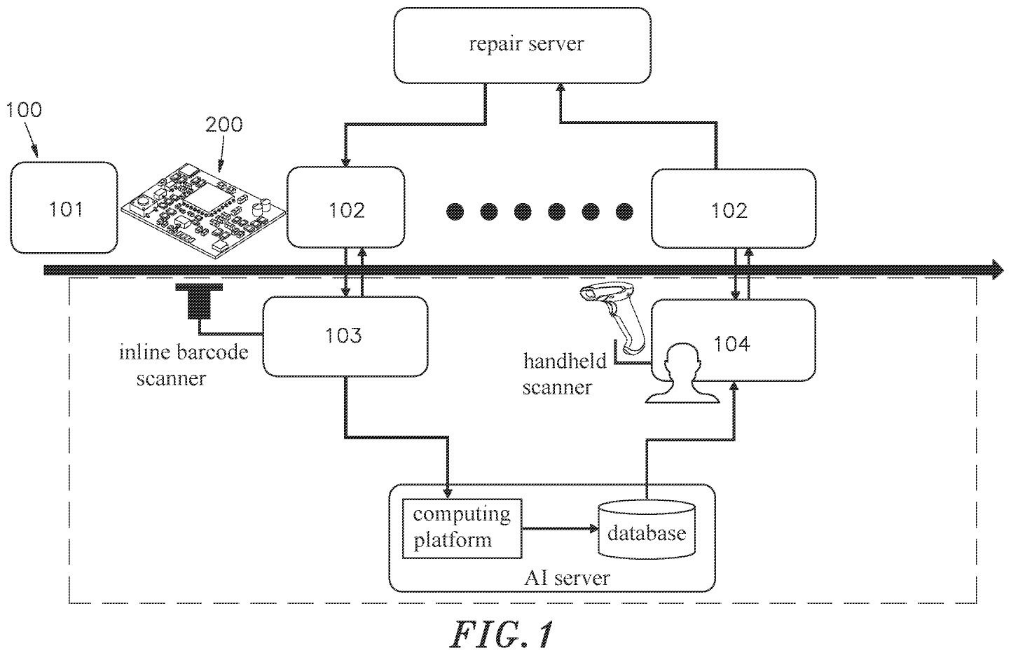

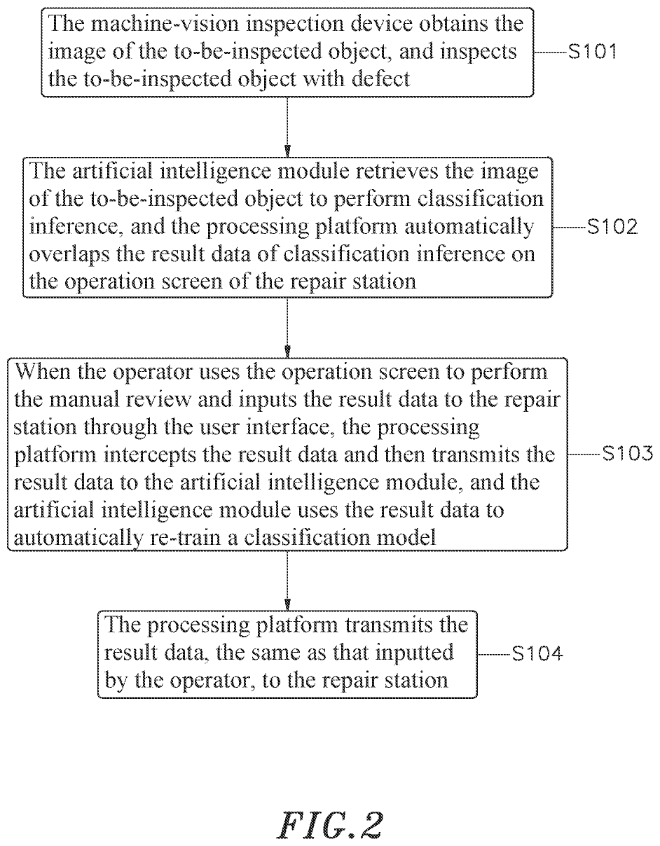

Please refer to FIGS. 1 to 4, which respectively are a schematic architecture view of an automated inspection system, a flowchart of an operating method, a schematic view showing an operation of intercepting a review result, which is inputted by the operator, training artificial intelligence and transmitting the same review result to a repair station, and a schematic view showing an operation of overlapping an AI inference result for classification on an operation screen, according to the present invention. As shown in FIG. 1, an automated inspection system 100 includes a machine-vision inspection device 101, a repair station 102, an artificial intelligence module 103 and a processing platform 104. The machine-vision inspection device 101 is configured to retrieve an image of a to-be-inspected object 200 delivered on a machine or a conveyor, and inspect the to-be-inspected object 200 with defect. The repair station 102 is connected to the machine-vision inspection device 101 and configured to receive the image of the to-be-inspected object 200 and display the image of the to-be-inspected object 200 on an operation screen 300 to assist an operator to perform a manual review. The artificial intelligence module 103 is connected to the machine-vision inspection device 1.01 and configured to retrieve the image of the to-be-inspected object 200 to automatically perform inference for classification of defects of the to-be-inspected object 200. The processing platform 104 is connected to the repair station 102 and the artificial intelligence module 103, and configured to receive an result data of classification inference from the artificial intelligence module 103 and overlap and display the result data of classification inference on the operation screen 300 of the repair station 102, so as to assist the operator to perform the manual review.

The present invention further provides an operating method of the automated inspection system, and the automated inspection system 100 includes the machine-vision inspection device 101, the repair station 102, the artificial intelligence module 103 and the processing platform 104. The operating method includes following steps S101 to S104.

In a step S101, the machine-vision inspection device 101 obtains the image of the to-be-inspected object 200, and inspects the to-be-inspected object 200 with defect.

In a step S102, the artificial intelligence module 103 retrieves the image of the to-be-inspected object 200 to perform classification inference, and the processing platform 104 automatically overlaps the result data of classification inference on the operation screen 300 of the repair station 102.

In a step S103, when the operator uses the operation screen 300 to perform the manual review and inputs the result data to the repair station 102 through the user interface, the processing platform 104 intercepts the result data and then transmits the result data to the artificial intelligence module 103. and the artificial intelligence module 103 uses the result data to automatically re-train a classification model.

In a step S104, the processing platform 104 transmits the result data, the same as that inputted. by the operator, to the repair station 102.

As shown in FIGS. 1 to 4, the machine-vision inspection device 101 used in the present invention can be an automated optical inspection (AOI) apparatus or an automated visual inspection (AVI) apparatus, and the machine-vision inspection device 101 can use a high-resolution camera to retrieve the image of the to-be-inspected object 200 delivered on the machine or the conveyor, and then use machine vision technology to inspect the to-be-inspected object 200 with defect. In a preferred embodiment, the to-be-inspected object 200 can be a printed circuit board assembly (PCBA), the machine-vision inspection device 101 can be applied to inspect the quality condition of the component soldered and assembled on the circuit board; however, the present invention is not limited to above-mentioned example, in an embodiment, the present invention can be applied to inspect and measure missing parts, holes, circuits or appearance of components during a manufacturing process related to the printed circuit board (PCB), chip carrier, flat-panel display (FPD), semiconductor, or electronic components.

In this embodiment, from the repair server, at least one repair station 102 obtains the image of the to-be-inspected object 200, and AOI image and defect data of the to-be-inspected object 200 detected by the multiple machine-vision inspection devices 101. The artificial intelligence module 103 can automatically scan a serial number (S/N) label or part number (P/N) label on the to-be-inspected object 200 by using an inline barcode scanner, and then retrieve the image of the to-be-inspected object 200 through a communication protocol of a display interface (e.g. VGA/DVI), and use a non-intrusive image extractor to perform digital image processing related to image cropping and optical character recognition (OCR), so as to extract information of the to-be-inspected object 200 and feature data of the image. Next, a computing platform of the AI server can use deep learning technology to automate the inference for classification of defects, and use a database to collect and store the information of the to-be-inspected objects 200 and the feature data of the images; alternatively, the robot process automation software (RPA) can be used to automatically access a manufacturing execution system (MES) and an enterprise management platform (such as SAP) to collect data and perform pre-processing, so as to provide the data required for deep learning operation.

In detail, the deep learning operation of the AI server mentioned above can be divided into a trained model and an inference mode. The deep learning operation is to extract available data from the database by performing algorithms; for example, the available data can he CSV which are comma-separated values stored as table data in a plain text file, or the available data can be images or texts. The extracted feature data is pre-processed and used in creation of a model for identification or classification to cluster the data with no label, and the data with labels can he used as samples for model training and learning to find the optimized deep learning model. After the process of model training and learning, the model can be used as a classifier for performing identification and classification on the data with no label, so as to autonomously perform classification or predictions in the inference mode. It should be noted that the deep learning technology used in the artificial intelligence module 103 can contain many different algorithms having different data collection process, modeling process, training process, evaluation process, parameter adjustment process, and prediction process, and both of the deep learning technology and machine learning technology are belonged to the category of artificial intelligence.

In the processing platform 104, a handheld scanner is used to automatically scan the product serial number (S/N) or the part number (P/N) label attached or printed on the to-be-inspected object 200, and the AI inference result of image classification generated by the artificial intelligence module 103 for the to-be-inspected object 200 is overlapped on a simulator corresponding to the repair station 102 by an automatic insertion or filling manner, so that the operation screen 300 can display different classification inference results to assist the operator to perform the review operation by viewing the operation screen 300, thereby decreasing the manual inspection items to make the operator focus on the review operation to improve operation quality. The operator can perform the review by using the input unit of the user interface such as a mouse, a keyboard or a touch screen, to label the defect on the image of the to-be-inspected object 200 as true or not, or label the classification result as correct or not. The processing platform 104 intercepts the validation operation or manual inspection result inputted by the operator and then transmits the inputted result or the result data of manual review to the AI server of the artificial intelligence module 103, so as to automate to perform re-training and validation process of the classification model; at the same time, the processing platform 104 can transmit the data, the same as the intercepted result data of manual review, to the repair station 102 for processing.

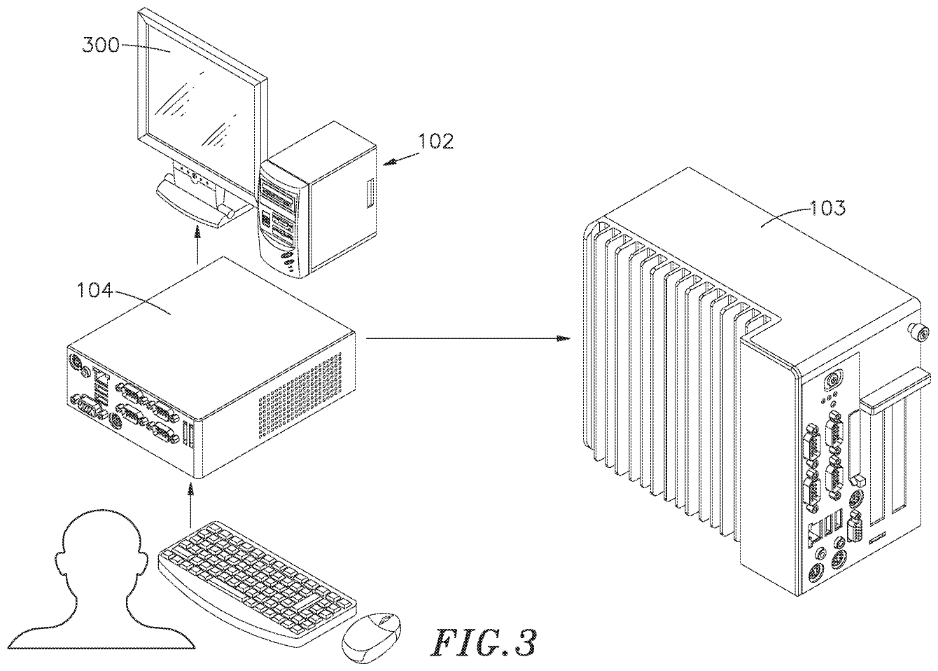

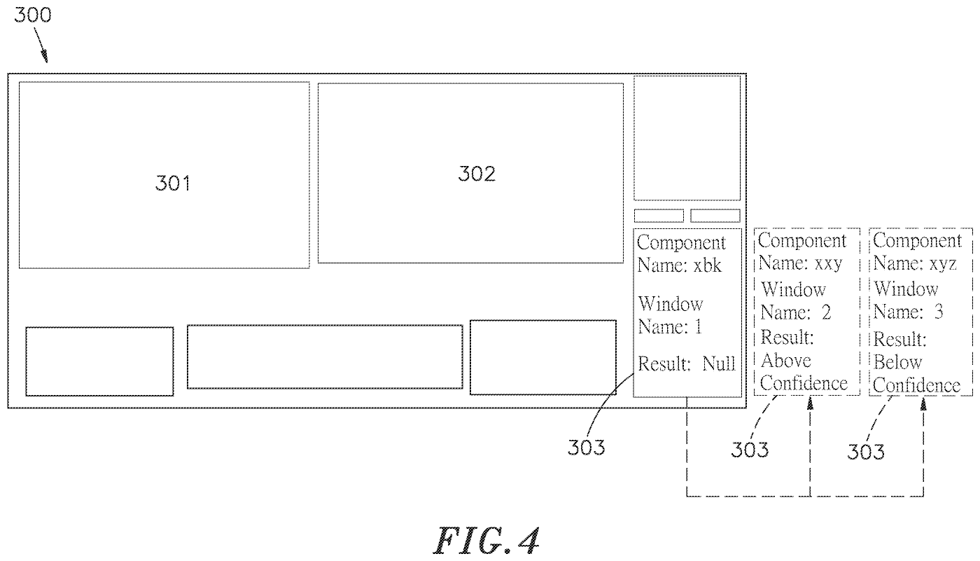

Please refer to FIGS. 3 and 4. The automated inspection system 100 applied in the present invention is non-intrusive and can be installed in the production line without stopping the production line, and can be introduced to the existing machine-vision inspection device 101 in the original production line; for example, the machine-vision inspection device 101 can be an automated optical inspection apparatus or an automated visual inspection apparatus. As a result, multiple machine-vision inspection devices 101 and multiple repair stations 102 can be installed in the production line to expand the processing scale, the artificial intelligence module 103 can use the barcode scanner to automatically scan the label on the to-be-inspected object 200, and can automatically crop the image of the to-be-inspected object 200 and extract the information of the to-be-inspected object 200 and the feature data detected by the machine-vision inspection device 101, and provide the information of the to-be-inspected object 200 and the feature data for AI training and inference. The result data of classification inference can be automatically overlapped on the operation screen 300 of the repair station 102 by the processing platform 104.

For example, the operation screen 300 of the repair station 102 mentioned above can include windows for various settings and basic operations of the host, setting of detection conditions, menus and data lists, an original image screen 301 of the to-be-inspected object 200, an image screen 302 of enlarged image of the to-be-inspected object 200, and a window 303 showing specific texts, different background colors or prompt colors used to represent different AI inference results for classification. The window 303 is a prompt window on which the processing platform 104 automatically overlaps the image classification inference result data of the to-be-inspected object 200 generated by the artificial intelligence module 103 on the operation screen 300. When the operator watches the operation screen 300 for review operation, the artificial intelligence module 103 can re-examine the to-be-inspected object 200 with defect detected by the machine-vision inspection device 101, so that the false positive rate can be decreased by more than 90% without using a large number of labelled image data or samples for training. The inference results for classification are overlapped on the operation screen 300, so that the operator can determine whether to perform the manual review according to the AI inference results classification displayed on the window 303; for example, the AI classification inference result can include “No Result”, “Above Confidence” and “Below Confidence”, it is easier for the operator to view the AI classification inference results, and the operator can be guided to accept the AI classification inference results through the interactive operation screen 300, so that the manual inspection items can be reduced. After the manual inspection items are greatly reduced, the operator can focus on review operation to improve the operation quality.

For example, when the AI classification inference result shown on the window 303 is

“No Result” or “ Below Confidence”, the operator can use the input unit (such as a mouse or a keyboard) to label the defect as true or not, on the image screen 302 of enlarged image of the to-be-inspected object 200; furthermore, the correct and incorrect options can be provided on the operation screen 300 for the operator to click, When the operator determines that the position of the defect labelled by the AI is different from that of the defect labelled manually, it means that the AI classification inference result is different from the actual results labelled in the manual review, and the difference may be caused by a classification error of the AI model or a manual labelling error, so that the manual review for confirmation of the accuracy of the label is required. The processing platform 104 can automatically intercept the validation operation or manual inspection result filled in by the operator, and transmit the result data of manual review and the related image to the AI server of the artificial intelligence module 103, to automatically perform the re-training and validation process of the classification model, and continue to train the deep learning model of the AI server until the artificial intelligence module 103 can autonomously perform classification determination or prediction or until the accuracy rate of prediction is no longer improved and the training process is stopped, so as to further decrease the missed detection rate or false positive rate of the automated inspection system 100, thereby improving the inspection quality.

The processing platform 104 of the automated inspection system 100 can collect the manual review results as the data for the artificial intelligence module 103 to perform re-training and learning of model. Furthermore, the re-training process is to add the result data of manual review to the learning sample database of the AI server, to enable the classification model to automatically adjust the parameters or weights of nodes, so as to achieve the effect of preventing the same or similar misjudged sample from being misjudged in further inspection process, thereby improving the accuracy of classifying or identifying the to-be-inspected object 200. Furthermore, all of the operator's past operating behaviors are stored, so that the operator can be quickly familiar with the new function added in the existing system, to shorten the learning curve of the operator through the interactive operation screen 300, and the overall inspection process can be shortened and the unit production capacity can it) be improved. Furthermore, the software and hardware of the present invention can be plugged in the original automated optical inspection apparatus system, and the original system and apparatus can be updated effectively and easily, and the complicated manual review inspection items can be reduced to effectively reduce labor costs and improve production and yield rate of the production line.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An automated inspection system, comprising:
a machine-vision inspection device configured to obtain an image of a to-be-inspected object to inspect the to-be-inspected object with defect;
a repair station connected to the machine-vision inspection device and configured to receive the image of the to-be-inspected object and display the image of the to-be-inspected object on an operation screen to assist an operator to perform a manual review;
an artificial intelligence module connected to the machine-vision inspection device and configured to retrieve the image of the to-be-inspected object to perform classification inference;
a processing platform connected to the repair station and the artificial intelligence module, configured to receive result data of classification inference from the artificial intelligence module, and integrate the result data on the operation screen of the repair station, to assist the operator to perform the manual review, wherein the processing platform is operative to:
automatically overlap the result data of classification inference, which is for classifying the image of the to-be-inspected object and generated by the artificial intelligence module, on the operation screen of the repair station;
intercept result data of manual review which is inputted to the repair station by the operator through a user interface;
transmit the result data of manual review to the artificial intelligence module as data for the artificial intelligence module to automatically re-train a classification model; and
transmit the result data, the same as that inputted by the operator, to the repair station.

2. The automated inspection system according to claim 1, wherein the machine-vision inspection device is an automated optical inspection apparatus or an automated visual inspection apparatus.

3. The automated inspection system according to claim 1, wherein the artificial intelligence module configured to obtain the image of the to-be-inspected object through a communication protocol of a display interface, and use a non-invasive image extractor to perform digital image processing of image cropping and optical character recognition to extract information of the to-be-inspected object and feature data of the image, and automatically perform defect classification inference by a deep learning technology.

4. The automated inspection system according to claim 3, wherein the artificial intelligence module collects and stores the information of the to-be-inspected object and the feature data of the image in a database.

5. The automated inspection system according to claim 1, wherein the processing platform overlaps the result data of classification inference to a UI simulator by an automatic insertion or filling manner, to display the different inference results on the operation screen.

6. The automated inspection system according to claim 5. wherein the operation screen comprises an original image screen and an image screen of enlarged image of the to-be-inspected object, and a window for displaying the different classification inference results.

7. The automated inspection system according to claim 5, wherein the operator uses an input unit of the user interface to label the image of the to-be-inspected object, and input a validation operation result or a manual inspection result of the operator, An operating method of an automated inspection system, wherein the automated inspection system comprises a machine-vision inspection device, a repair station, an artificial intelligence module, and a processing platform, and the operating method comprises:
using the machine-vision inspection device to obtain an image of a to-be-inspected object and inspect the to-be-inspected object with defect;
using the artificial intelligence module to obtain the image of the to-be-inspected object to perform classification inference, and automatically overlap result data of classification inference on an operation screen of the repair station through the processing platform;
when an operator uses the operation screen to perform a manual review, the result data inputted to the repair station through a user interface is intercepted by the processing platform and transmitted to the artificial intelligence module, as data for the artificial intelligence module to automatically re-train a classification model and using the processing platform to transmit the result data which is the same as that inputted by the operator, to the repair station.
